(19) United States
(12) Patent Application Publication
(10) Pub. No.: US 2013/0304462 A1
(43) Pub. Date: Nov. 14, 2013

(54) SIGNAL PROCESSING APPARATUS AND METHOD AND PROGRAM

(71) Applicant: SONY CORPORATION, Tokyo (JP)

(72) Inventors: Takeshi Yamaguchi, Kanagawa (JP); Yasuhiko Kato, Kanagawa (JP)

(73) Assignee: Sony Corporation, Tokyo (JP)

(21) Appl. No.: 13/875,429

(22) Filed: May 2, 2013

(30) Foreign Application Priority Data
May 9, 2012 (JP) 2012-107458

(51) Int. Cl. G10L 15/00

(52) U.S. Cl. CPC G10L 15/00
USPC 704/231

(57) ABSTRACT

Disclosed herein is a signal processing apparatus including: a first A/D converter configured to execute A/D conversion by adjusting an input signal with a first gain; a second A/D converter configured to execute A/D conversion by adjusting an input signal with a second gain that is smaller than the first gain; a synthesis block configured to synthesize a first signal obtained by conversion by the first A/D converter with a second signal obtained by conversion by the second A/D converter to output a resultant synthesized signal if the first signal is clipped; and a signal processing block configured to execute signal processing by use of the signal outputted from the synthesis block.

### BACKGROUND

The present disclosure relates to a signal processing apparatus and method and a program and, more particularly, to a signal processing apparatus and method and a program that are configured to mitigate the drop in the processing performance caused by clipping.

In related-art technologies, inputting a very loud sound through a microphone causes clipping at the time of A/D (Analog/Digital) conversion, leading to the loss of information. In voice recognition systems, attempting analysis on the clipped sound results in an incorrect analysis, thereby significantly lowering the performance of recognition.

In order to circumvent the above-mentioned problem, a technology disclosed in Japanese Patent Laid-open No. 2008-129084 (hereinafter referred to as Patent Document 1) was proposed in which, upon the occurrence of clipping, the clipped data is discarded and a speaker is notified thereof, thereby prompting the speaker to utter again.

### SUMMARY

However, the method disclosed in Patent Document 1 mentioned above imposes an excess load to the speaker by requesting the speaker to repeat speaking. For example, if the speaker is aware that the speaker is speaking to a voice recognition system, then it is practicable to take actions accordingly on the side of the system; on the other hand, if the speaker is unaware of the system, then it is impossible to prompt the speaker to speak again for voice recognition.

In addition, in the case of systems configured to detect an unusual sound such as the sound of gunfire, it is impracticable to prompt the resounding of unusual sounds.

In order to overcome the above-mentioned problem, it is possible to provide the arrangement of A/D conversion having a gain that does not cause clipping against loud sounds. However, with such an arrangement, the resolution for lower sounds is deteriorated if sounds having largely different gains of a human voice and a sound of gunfire are processed at the same time, thereby lowering the performance of the system concerned, for example. In that case, influence from noise becomes significant, which also lower the performance.

Therefore, the present disclosure addresses the above-identified and other problems associated with related-art methods and apparatuses, and it is desirable to provide a signal processing apparatus and method and a program that are configured to mitigate the lowering of the processing performance caused by clipping.

According to an embodiment of the present disclosure, there is provided a signal processing apparatus including: a first A/D converter configured to execute A/D conversion by adjusting an input signal with a first gain; a second A/D converter configured to execute A/D conversion by adjusting an input signal with a second gain that is smaller than the first gain; a synthesis block configured to synthesize a first signal obtained by conversion by the first A/D converter with a second signal obtained by conversion by the second A/D converter to output a resultant synthesized signal if the first signal is clipped; and a signal processing block configured to execute signal processing by use of the signal outputted from the synthesis block.

According to another embodiment of the present disclosure, there is provided a signal processing method executed by a signal processing apparatus, including: executing first A/D conversion by adjusting an input signal with a first gain; executing second A/D conversion by adjusting an input signal with a second gain that is smaller than the first gain; synthesizing a first signal obtained by the first A/D conversion with a second signal obtained by the second A/D conversion to output a resultant synthesized signal if the first signal is clipped; and executing signal processing by use of the signal thus synthesized and outputted.

According to a further embodiment of the present disclosure, there is provided a program configured to cause a computer to execute processing including: executing A/D conversion by adjusting an input signal with a first gain by a first A/D converter; executing A/D conversion by adjusting an input signal with a second gain that is smaller than the first gain by a second A/D converter; synthesizing a first signal obtained by conversion by the first A/D converter with a second signal obtained by conversion by the second A/D converter to output a resultant synthesized signal if the first signal is clipped; and executing signal processing by use of the signal thus synthesized and outputted.

According to the above-mentioned embodiments of the present disclosure, an input signal is adjusted by the first gain to execute the first A/D conversion and an input signal is adjusted by the second gain smaller than the first gain to execute the second A/D conversion. Then, if the first signal obtained by the first A/D conversion is clipped, the first signal and the second signal obtained by the second A/D conversion are synthesized with each other to be outputted. Signal processing is executed by use of this outputted synthesized signal.

According to the above-mentioned embodiments of the present disclosure, signal processing can be realized. Especially, the lowering of processing performance due to clipping can be mitigated.

### BRIEF DESCRIPTION OF THE DRAWINGS

Other objects and advantages of the disclosure will become apparent from the following description of embodiments with reference to the accompanying drawings in which:

FIG. 1 is a block diagram illustrating an exemplary configuration of a voice recognition system according to a first embodiment of the present disclosure;

FIG. 2 is a diagram illustrating synthesis processing to be executed by a synthesis block according to the first embodiment;

FIG. 3 is a flowchart indicative of one example of signal processing according to the first embodiment;

FIG. 4 is a block diagram illustrating an exemplary configuration of a voice recognition system according to a second embodiment;

FIG. 5 is a diagram illustrating synthesis processing to be executed by a synthesis block according to the second embodiment;

FIG. 6 is a flowchart indicative of one example of signal processing according to the second embodiment;

FIG. 7 is a flowchart indicative of another example of signal processing according to the second embodiment;

FIG. 8 is a flowchart indicative of still another example of signal processing according to the second embodiment; and

FIG. 9 is a block diagram illustrating an exemplary configuration of a computer.

### DETAILED DESCRIPTION OF THE PREFERRED EMBODIMENTS

The technology disclosed herein will be described in further detail by way of embodiments thereof with reference to the accompanying drawings. The description will be done in the following order.
1. First Embodiment
2. Second Embodiment

### 1. First Embodiment

### [Exemplary Configuration of Voice Recognition System]

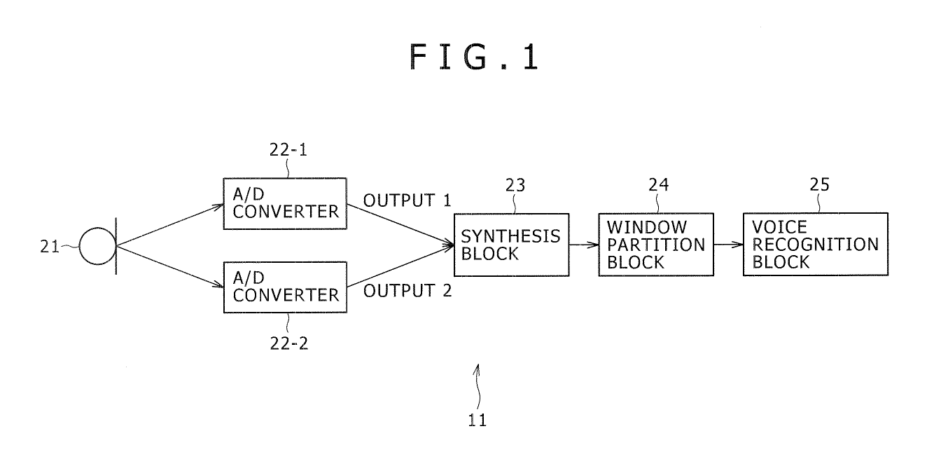

Referring to FIG. 1, there is shown an exemplary configuration of a voice recognition system that is a signal processing apparatus based on the present disclosure. It should be noted that, in the example shown in FIG. 1, the parts not related with the description of the present disclosure are not shown.

In the example shown in FIG. 1, a voice recognition system 11 includes a microphone 21, A/D converters 22-1 and 22-2, a synthesis block 23, a window partition block 24, and a voice recognition block 25.

The microphone 21 enters a voice into the voice recognition system 11. The voice entered through the microphone 21 is outputted to the two A/D converters 22-1 and 22-2.

The A/D converters 22-1 and 22-2 have different gain settings. In the A/D converter 22-1, a first gain is set. In the A/D converter 22-2, a second gain smaller than the first gain is set.

The A/D converter 22-1 adjusts (or amplifies) the entered voice (in an analog signal) with the first gain and executes A/D conversion on the gain-adjusted analog signal, thereby converting into a digital signal. The A/D converter 22-1 outputs this digital signal to the synthesis block 23 as output 1.

The A/D converter 22-2 adjusts the entered voice (in an analog signal) with the second gain and executes A/D conversion on the gain-adjusted analog signal, thereby converting into a digital signal. The A/D converter 22-2 outputs this digital signal to the synthesis block 23 as output 2.

Basically, the output 1 from the A/D converter 22-1 is used for the voice recognition in a later stage. Therefore, the first gain is set such that the resolution of the output 1 from the A/D converter 22-1 becomes equal to or higher than the resolution that is lowest necessary for the voice recognition. That is, the A/D converter 22-1 is higher in resolution than the A/D converter 22-2.

The second gain is set such that gain adjustment is made smaller (or lower) than the first gain. Consequently, if clipping occurs by the first gain in the A/D converter 22-1, no clipping is caused with the second gain in the A/D converter 22-2.

The synthesis block 23 determines whether or not the output 1 that is the digital signal from the A/D converter 22-1 is clipped. This determination can be done by if the output 1 of the digital signal is the maximum value thereof.

If no clipping is found, the synthesis block 23 outputs the output 1 from the A/D converter 22-1 to the window partition block 24 in the following stage. If clipping is found, then the synthesis block 23 synthesizes the output 1 from the A/D converter 22-1 with the output 2 from the A/D converter 22-2 and outputs a resultant signal to the window partition block 24 in the following stage.

The window partition block 24 enters the signal supplied from the synthesis block 23. This signal is a time-series continuous signal. Therefore, the window partition block 24 partitions the entered time-series continuous signal into window widths of FFT (Fast Fourier Transform) to be executed by the voice recognition block 25 and outputs a signal of each window width to the voice recognition block 25.

The voice recognition block 25 executes voice recognition processing as signal processing on the signal of each window width supplied from the window partition block 24. The voice recognition block 25 executes voice recognition processing such as FFT, feature extraction, and likelihood computation based on model comparison on the signal of each window width supplied from the window partition block 24, thereby obtaining a voice recognition result. The voice recognition result obtained by the voice recognition block 25 is used in a following stage, now shown.

### [Description of Synthesis Processing]

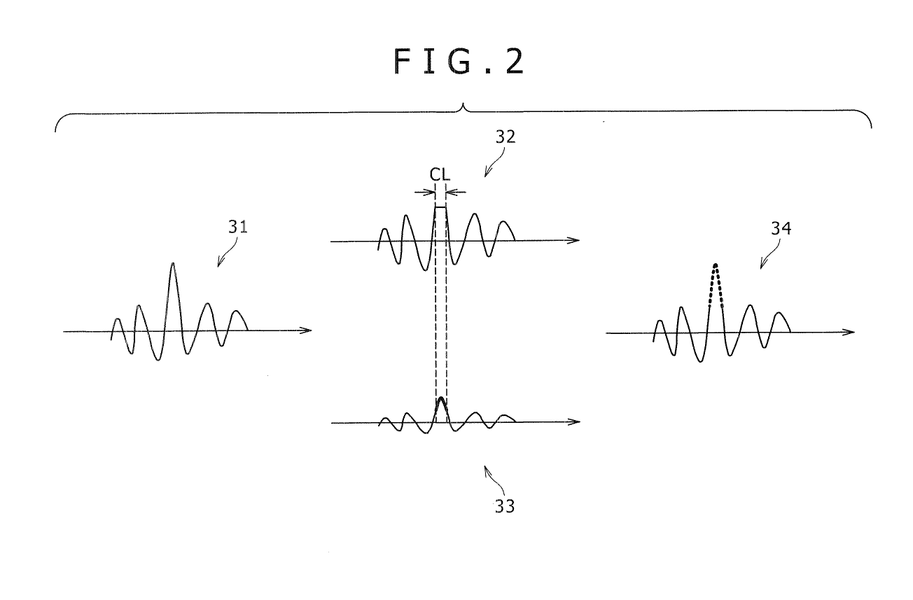

The following describes one example of synthesis processing to be executed by the synthesis block 23 with reference to FIG. 2.

The example shown in FIG. 2 is indicative of a waveform 31 of an input signal into the A/D converters 22-1 and 22-2, a waveform 32 of an output signal from the A/D converter 22-1, a waveform 33 of an output signal from the A/D converter 22-2, and a waveform 34 of an output signal obtained by the synthesis by the synthesis block 23.

An input signal having a volume indicated by the waveform 31 is entered from the microphone 21 into the A/D converters 22-1 and 22-2.

The A/D converter 22-1 executes A/D conversion on the input signal having the waveform 31 by executing gain adjustment with the first gain. However, in the A/D converter 22-1, part (hereafter referred to as a CL section) of a signal gain-adjusted with the first gain is clipped, whereby an output signal having the waveform 32 with the CL section clipped is outputted from the A/D converter 22-1.

The A/D converter 22-2 executes A/D conversion on the input signal having the waveform 31 by gain adjustment with the second gain. Because the second gain is set such that the signal of the second gain is adjusted to become smaller than that of the first gain, an output signal having the waveform 33 having no clipping is outputted from the A/D converter 22-2.

The synthesis block 23 determines whether or not clipping has occurred by determining whether or not the output signal having the waveform 32 supplied from the A/D converter 22-1 has the maximum value thereof. If clipping is found in the signal having the waveform 32, then the synthesis block 23 synthesizes the signal of the waveform 32 with the signal of the waveform 33 and outputs a resultant signal to the window partition block 24 in the following stage.

To be more specific, the synthesis block 23 executes synthesis by replacing only the CL section having clipping of the signals having the waveform 32 with a value obtained by adjusting the signal having the waveform 33 indicated by a thick line using a difference between the first gain and the second gain. This difference between the first gain and the second gain is stored in the synthesis block 23 in advance.

In the synthesis block 23, as shown with a dashed thick line, a synthesis signal having the waveform 34 with the CL section in the waveform 32 replaced with a value obtained by increasing the waveform 33 by the difference between the first gain and the second gain is obtained.

In the voice recognition processing in the following stage, a signal having the waveform 34 with the CL section not clipped is used, so that the degradation in the performance of voice recognition can be lowered.

It should be noted that, if no clipping is found in the signal of the waveform 32, then the synthesis block 23 outputs the signal of the waveform 32 to the window partition block 24 in the following stage.

### [Example of Voice Signal Processing]

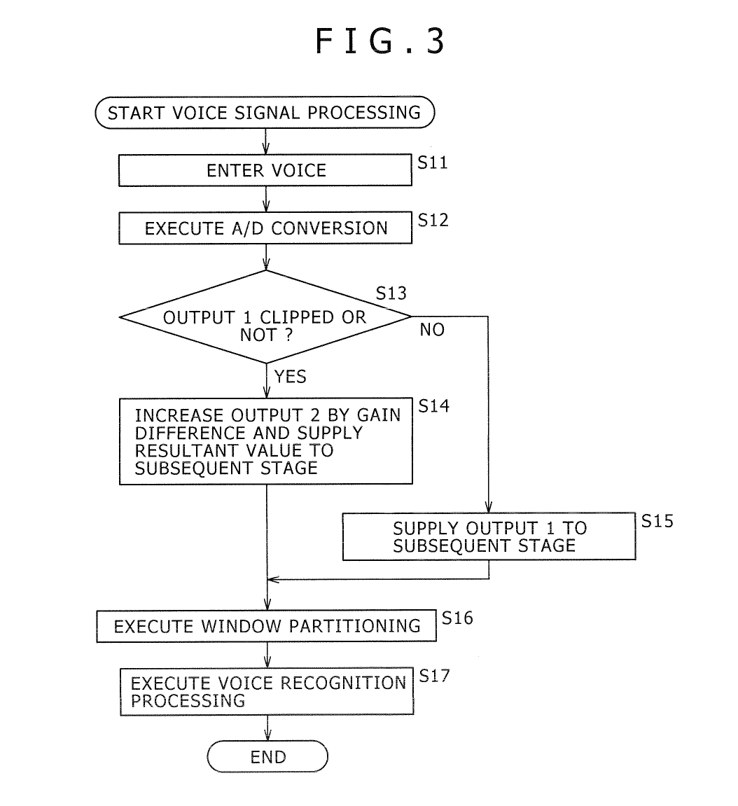

The following describes voice signal processing to be executed by the voice recognition system 11 with reference to the flowchart shown in FIG. 3

In step S11, the microphone 21 enters a voice. The voice entered through the microphone 21 is outputted to the two A/D converters 22-1 and 22-2.

In step S12, the A/D converters 22-1 and 22-2 execute A/D conversion on the signal supplied from the microphone 21.

To be more specific, the A/D converter 22-1 gain-adjusts (or amplifies) the entered voice (an analog signal) with the first gain and executes A/D conversion on the gain-adjusted analog signal into a digital signal. The A/D converter 22-1 outputs the resultant digital signal to the synthesis block 23 as the output 1.

The A/D converter 22-2 gain-adjusts the entered voice (an analog signal) with the second gain and executes A/D conversion on the gain-adjusted analog signal into a digital signal. The A/D converter 22-2 outputs the resultant digital signal to the synthesis block 23 as the output 2.

In step S13, the synthesis block 23 determines whether or not the output 1 that is the digital signal supplied from the A/D converter 22-1 is clipped. If the output 1 is found to have been clipped in step S13, then the procedure goes to step S14.

In step S14, the synthesis block 23 outputs the output 1 to the following stage for the section having no clipping and, for the clipped CL section, increases the output 2 by the gain difference, supplying a resultant value to the following stage. That is, the synthesis block 23 synthesizes the output 1 from the A/D converter 22-1 with the output 2 from the A/D converter 22-2 and outputs a resultant signal to the window partition block 24 in the following stage.

If no clipping is found in step S13, then the procedure goes to step S15. In step S15, the synthesis block 23 supplies the output 1 supplied from the A/D converter 22-1 to the window partition block 24 in the following stage.

In step S16, the window partition block 24 executes window partitioning on the signal supplied from the synthesis block 23. The window partition block 24 partitions the entered time-series continuous signal into window widths of FFT to be executed by the voice recognition block 25 and outputs a signal of each window width to the voice recognition block 25.

In step S17, the voice recognition block 25 executes voice recognition processing on the signal of each window width supplied from the window partition block 24 to get a voice recognition result. The voice recognition result obtained from the voice recognition block 25 is used in a following stage, not shown.

As described above, of the signal after A/D conversion, the clipped section is replaced by a signal after A/D conversion having a smaller gain, so that the loss of a signal due to clipping can be prevented. If a signal is lost, nothing can be done. By this configuration, the performance of signal processing, namely, the performance of voice recognition can be enhanced.

In the signal replacement, the replacement signal is adjusted to be increased by the gain difference, so that the deterioration due to the low signal resolution can be minimized.

### 2. Second Embodiment

### [Another Exemplary Configuration of Voice Recognition System]

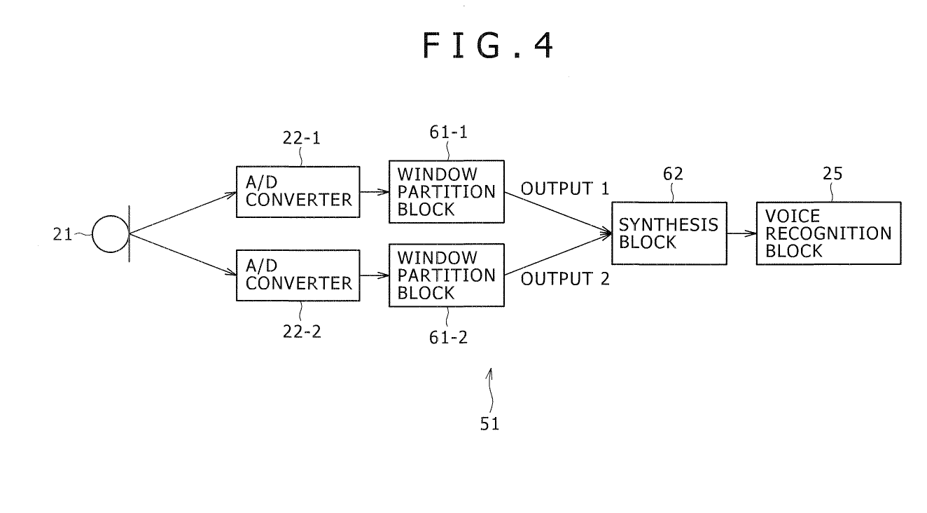

Referring to FIG. 4, there is shown another exemplary configuration of the voice recognition system that is the signal processing apparatus based on the present disclosure.

In the example shown in FIG. 4, a voice recognition system 51 includes the microphone 21, the A/D converters 22-1 and 22-2, window partition blocks 61-1 and 61-2, a synthesis block 62, and the voice recognition block 25.

It should be noted that the voice recognition system 51 is common to the voice recognition system 11 shown in FIG. 1 in the microphone 21, the A/D converters 22-1 and 22-2, and the voice recognition block 25,

The voice recognition system 51 differs from the voice recognition system 11 shown in FIG. 1 in that the synthesis block 23 is replaced by the synthesis block 62 and the window partition block 24 is replaced by the window partition blocks 61-1 and 61-2.

To be more specific, the order of the synthesis block and the window partition blocks in the voice recognition system 51 is reverse to the order of the synthesis block and the window partition block in the voice recognition system 11 shown in FIG. 1.

The A/D converter 22-1 gain-adjusts (or amplifies) an entered voice by the first gain and executes A/D conversion on the gain-adjusted analog signal into a digital signal. The A/D converter 22-1 outputs this digital signal to the window partition block 61-1.

The A/D converter 22-2 gain-adjusts an entered voice by the second gain and executes A/D conversion on the gain-adjusted analog signal into a digital signal. The A/D converter 22-2 outputs this digital signal to the window partition block 61-2.

The window partition block 61-1 partitions a time-series continuous signal supplied from the A/D converter 22-1 into window widths of FFT to be executed by the voice recognition block 25 and outputs a signal of each window width to the synthesis block 62 as output 1.

The window partition block 61-2 partitions a time-series continuous signal supplied from the A/D converter 22-2 into window widths of FFT to be executed by the voice recognition block 25 and outputs a signal of each window width to the synthesis block 62 as output 2.

A digital signal of each window width from the window partition block 61-1 and a digital signal of each window width from the window partition block 61-2 are entered in the synthesis block 62. The synthesis block 62 determines whether or not the output 1 that is the digital signal from the window partition block 61-1 is clipped for each window section. This determination can be done by determining whether or not the output 1 that is the digital signal takes a maximum value.

If no clipping is found, then the synthesis block 62 outputs the output 1 supplied from the window partition block 61-1 to the voice recognition block 25 in the following stage. If clipping is found, then the synthesis block 62 synthesizes the output 1 from the window partition block 61-1 with the output 2 from the window partition block 61-2 for the signal of the clipped window section and outputs a resultant signal to the voice recognition block 25 in the following stage.

The voice recognition block 25 executes voice recognition processing as signal processing on the signal of each window width supplied from the synthesis block 62. The voice recognition block 25 executes voice recognition processing such as FFT, feature extraction, and likelihood computation based on model comparison on the signal of each window width supplied from the synthesis block 62, thereby obtaining a voice recognition result. The voice recognition result obtained by the voice recognition block 25 is used in a following stage, now shown.

### [Description of Synthesis Processing]

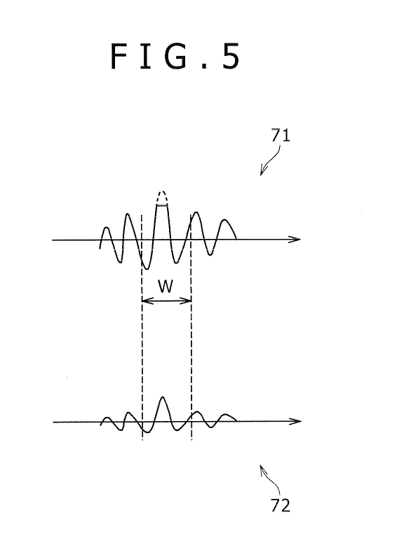

The following describes one example of synthesis processing to be executed by the synthesis block 62 with reference to FIG. 5.

In the example shown in FIG. 5, a waveform 71 of an output signal supplied from the window partition block 61-1 and a waveform 72 of an output signal supplied from the window partition block 61-2 are shown.

The waveform 71 of the output signal from the window partition block 61-1 is gain-adjusted by the first gain and A/D-converted. The waveform 72 of the output signal from the window partition block 61-2 is gain-adjusted by the second gain and A/D converted.

The synthesis block 62 determines whether or not the signal having the waveform 71 is clipped for each window section W. If clipping is found in a window section W of the signal having the waveform 71 as indicated by a dashed line, for example, then the synthesis block 62 synthesizes the signal of the waveform 71 with the signal of the waveform 72 and outputs a resultant synthesized signal to the voice recognition block 25.

To be more specific, the synthesis block 62 synthesizes the signal having the waveform 72 for the window section W having clipping and the signal having the waveform 71 for another window section having no clipping and outputs the synthesized signals to the following stage.

It should be noted that, in the above-mentioned case, for the window section W having clipping, information indicative of a difference between the first gain and the second gain is supplied to the voice recognition block 25 as required. This difference between the first gain and the second gain is stored in the synthesis block 62 in advance.

As described above, because signals having no clipping are used in the following voice recognition processing, the deterioration in the performance of voice recognition can be minimized.

### [Example of Voice Signal Processing]

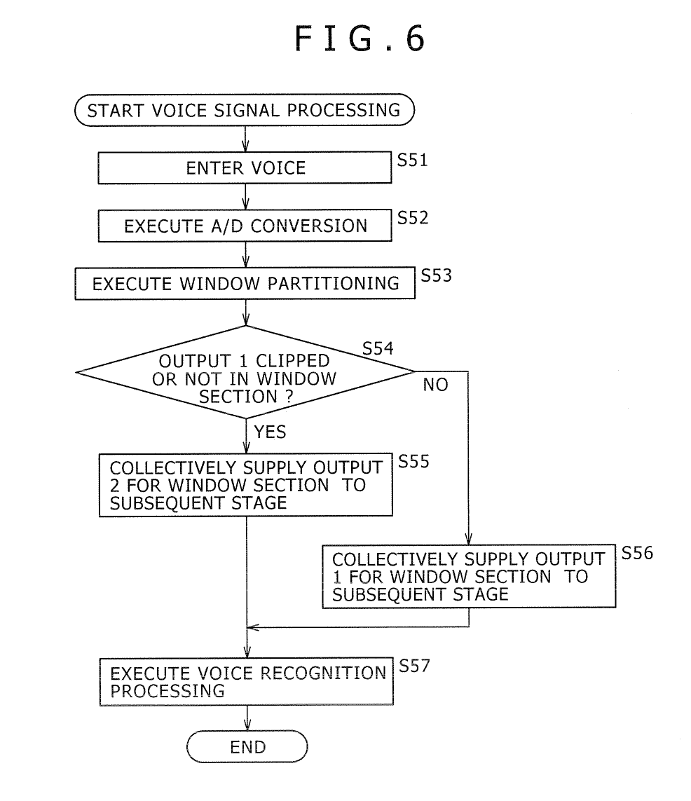

The following describes voice signal processing to be executed by the voice recognition system 51 with reference to the flowchart shown in FIG. 6.

In step S51, the microphone 21 enters a voice. The voice entered through the microphone 21 is outputted to the two A/D converters 22-1 and A/D converter 22-2.

In step S52, the A/D converters 22-1 and 22-2 execute A/D conversion on the signals supplied from the microphone 21.

To be more specific, the A/D converter 22-1 gain-adjusts (or amplifies) the entered signal (an analog signal) by the first gain and executes A/D conversion on the gain-adjusted analog signal into a digital signal. The A/D converter 22-1 outputs this digital signal to the window partition block 61-1.

The A/D converter 22-2 gain-adjusts the entered voice (an analog signal) by the second gain and executes A/D conversion on the gain-adjusted analog signal into a digital signal. The A/D converter 22-2 outputs this digital signal to the window partition block 61-2.

In step S53, the window partition blocks 61-1 and 61-2 execute window partitioning on the entered digital signals.

To be more specific, the window partition block 61-1 partitions a time-series continuous signal supplied from the A/D converter 22-1 into window widths of FFT to be executed by the voice recognition block 25 and outputs the signal of each window width to the synthesis block 62 as the output 1.

The window partition block 61-2 partitions a time-series continuous signal supplied from the A/D converter 22-2 into window widths of FFT to be executed by the voice recognition block 25 and outputs the signal of each window width to the synthesis block 62 as the output 2.

In step S54, the synthesis block 62 determines whether or not the output 1 that is the digital signal from the window partition block 61-1 is clipped in the window section. If the output 1 is found clipped in the window section in step S54, then the procedure goes to step S55.

In step S55, the synthesis block 62 supplies the output 2 supplied from the window partition block 61-2 collectively for the window section to the following stage. A window section of the clipped output 1 is replaced by a window section of the output 2 to be outputted.

It should be noted that, in the above-mentioned case, for the window section W having clipping, information indicative of the difference between the first gain and the second gain is supplied to the voice recognition block 25 as required.

If the output 1 is found not clipped in the window section in step S54, then the procedure goes to step S56. In step S56, the synthesis block 62 supplies the output 1 from the window partition block 61-1 collectively for the window section to the voice recognition block 25.

To be more specific, depending on whether or not clipping is found in each window section, the synthesis block 62 synthesizes the output 1 from the window partition block 61-1 with the output 2 from the window partition block 61-2 and outputs a resultant synthesized signal to the voice recognition block 25 in the following stage.

In step S57, the voice recognition block 25 executes voice recognition processing on the signal for each window width supplied from the synthesis block 62, thereby obtaining a voice recognition result. The voice recognition result obtained by the voice recognition block 25 is used in a following stage, not shown.

As described above, in the signal after A/D conversion, the presence or absence of clipping is determined in each window section and the clipped window section is replaced by an A/D-converted signal having a smaller gain.

The loss of signals due to clipping can be thus prevented. As a result, the performance of voice recognition can be enhanced.

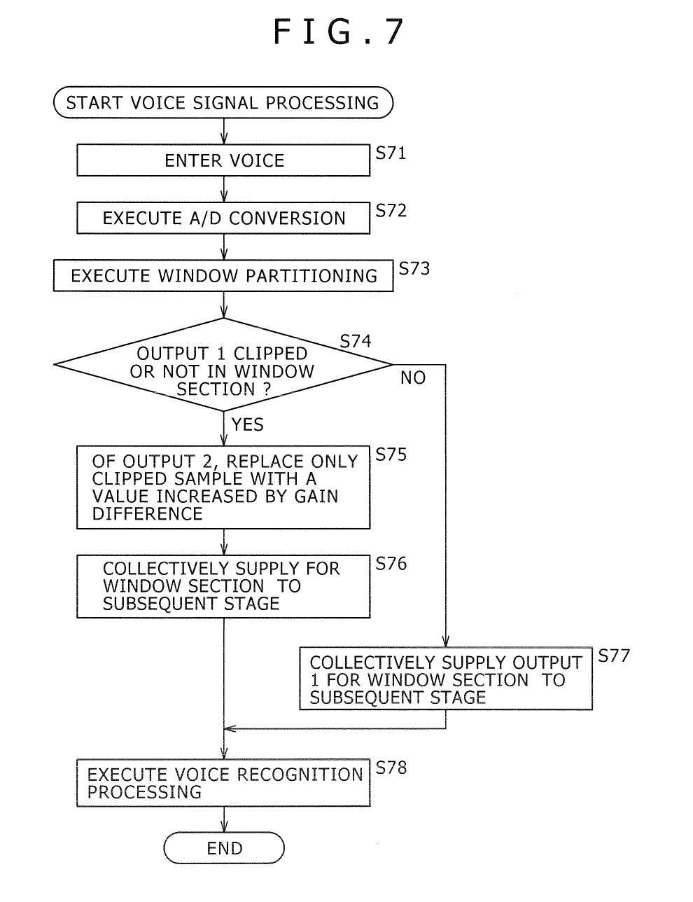

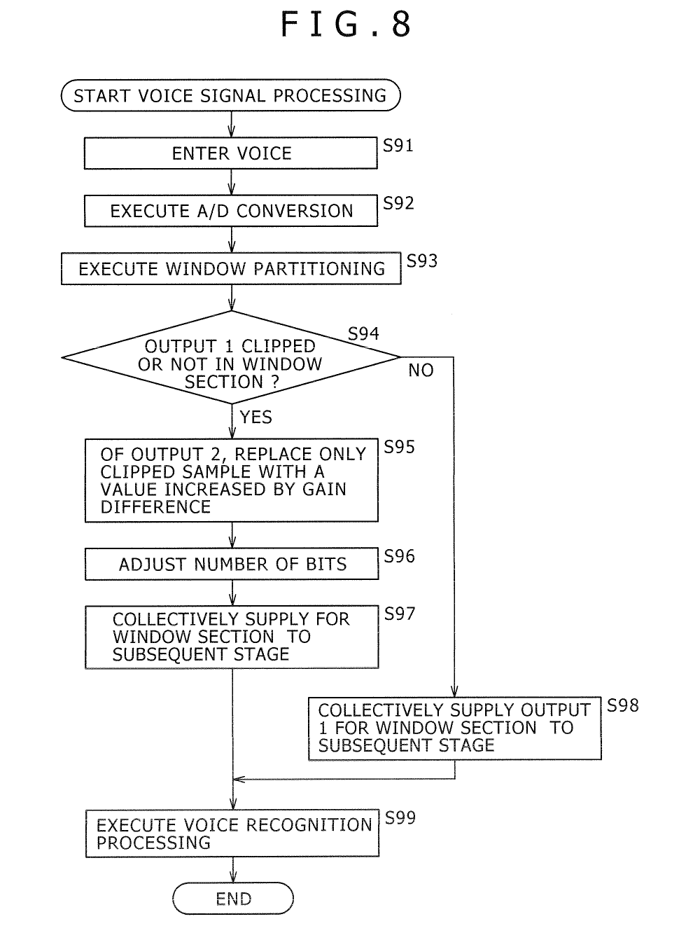

It should be noted that the synthesis processing to be executed when clipping is found is not limited to the example shown in FIG. 6; it is also practicable to execute synthesis processing as shown in FIG. 7 or FIG. 8.

### [Another Example of Voice Signal Processing]

The following describes another example of voice signal processing to be executed by the voice recognition system 51 with reference to the flowchart shown in FIG. 7. It should be noted that steps S71 through S74 and steps S76 through S78 shown in FIG. 7 are basically the same as steps 551 through S57 shown in FIG. 6, so that the description thereof will be skipped as appropriate.

If the output 1 is found clipped in the window section in step S74, the procedure goes to step S75.

In step S75, of the output 1 from the window partition block 61-1, the synthesis block 62 replaces only the clipped sample by a value obtained by increasing the output 2 from the window partition block 61-2 by the gain difference.

In step S76, the synthesis block 62 supplies the output collectively for the window section, in which only the clipped sample has been replaced, to the voice recognition block 25 in the following stage.

If the output 1 is found not clipped in the window section in step S74, then the procedure goes to step S77. In step S77, the synthesis block 62 supplies the output 1 from the window partition block 61-1 collectively for the window section to the voice recognition block 25 in the following stage.

Depending on whether or not clipping is found for each window section, the synthesis block 62 synthesizes the output 1 from the window partition block 61-1 and the output 2 from the window partition block 61-2 and outputs a resultant synthesized signal to the voice recognition block 25 in the following stage.

In step S78, the voice recognition block 25 executes voice recognition processing on the signal of each window width supplied from the synthesis block 62, thereby obtaining a voice recognition result. The voice recognition result obtained by the voice recognition block 25 is used in a following stage, not shown.

As described above, of the clipped window section, only the clipped sample is replaced by a value obtained by increasing the signal after A/D conversion having a smaller gain by the gain difference.

The loss of a signal due to clipping can be thus prevented. As a result, the performance of voice recognition can be enhanced.

In the signal replacement, the replacement signal is adjusted to be increased by the gain difference, so that the deterioration due to the low signal resolution can be minimized.

### [Still Another Example of Voice Signal Processing]

The following describes still another example of voice signal processing to be executed by the voice recognition system 51 with reference to the flowchart shown in FIG. 8. It should be noted that steps S91 through S95 and steps S97 through S99 shown in FIG. 8 are basically the same as steps S71 through S78 shown in FIG. 7, so that the description thereof will be skipped as appropriate.

If the output 1 is found clipped in the window section in step S94, then the procedure goes to step S95.

In step S95, of the window section of the output 1 from the window partition block 61-1, the synthesis block 62 replaces only the clipped sample by a value obtained by increasing the output 2 from the window partition block 61-2 by the gain difference.

In step S96, the synthesis block 62 executes the adjustment of the number of bits on the window section in which only the clipped sample has been replaced. That is, the synthesis block 62 executes the adjustment of the number of bits on the window section in which only the clipped sample has been replaced such that the number of bits fits a specified number of bits of input into the voice recognition block 25.

In step S97, the synthesis block 62 outputs the output collectively for the window section adjusted in the number of bits to the voice recognition block 25 in the following stage.

At this moment, information indicative of how many bits have been adjusted is also supplied to the voice recognition block 25 as required.

If the output 1 is found not clipped in the window section in step S94, then the procedure goes to step S98. In step S98, the synthesis block 62 supplies the output 1 supplied from the window partition block 61-1 collectively for the window section to the voice recognition block 25 in the following stage.

To be more specific, depending on whether or not clipping is found for each window section, the synthesis block 62 synthesizes the output 1 from the window partition block 61-1 with the output 2 from the window partition block 61-2 and outputs a resultant synthesized signal to the voice recognition block 25 in the following stage.

In step S99, the voice recognition block 25 executes voice recognition processing on the signal for each window width supplied from the synthesis block 62, thereby obtaining a voice recognition result. The voice recognition result obtained by the voice recognition block 25 is used in a following stage, not shown.

It should be noted that the information indicative of how many bits have been adjusted, the information to be supplied to the voice recognition block 25 in step S97 shown in FIG. 8, is used in the voice recognition block 25 for extracting a power as a feature, for example.

In computing a power or a power as a feature, if the gain difference is unknown, it is possible that no correct value is obtained. For example, if the power of an actual sound is 10 in a preceding frame and 20 in a following frame, then, if the gain of the preceding frame is the same as the gain of the following frame, an output value from the preceding frame is 10 and an output value from the following frame is 20. Therefore, these values may be used without change to correctly compute the power.

It should be noted however that, if the gain of the preceding frame differs from the gain of the following frame by 12 dB, the output value from the preceding frame becomes 10 and the output value from the following frame becomes 5, so that if the gain difference is unknown, no correction can be done, thereby making it impossible to compute a correct feature. In this case, supplying information indicative that the gain difference between the preceding and following frames is 12 dB allows a correction with the power of the preceding frame being 10 and the power of the following frame being 5×12 dB=20. A feature can be thus extracted correctly. It should be noted that, although the description is skipped, the information indicative of the gain difference supplied in step S55 shown in FIG. 6 is used also in the same manner.

As described above, of the clipped window section, only the clipped sample is replaced by a value obtained by increasing the signal after A/D conversion having a smaller gain by the gain difference, and the number of bits is adjusted.

The above-mentioned configuration allows further prevention of the loss of signals due to clipping. As a result, the performance of voice recognition can be enhanced.

The examples shown in FIG. 6 through FIG. 8 were used as examples of determining the presence or absence of clipping for each window section. In the example shown in FIG. 6, synthesis processing is not required, so that the determination of clipping can be handled with a relatively small computation amount. In the example shown in FIG. 7, the processing can be executed without lowering the resolution. In the example shown in FIG. 8, output may be executed with a higher resolution than that of the example shown in FIG. 6. In addition, because the number of bits of the output to the processing in the following stage becomes constant, the configuration of the processing in the following stage is not complicated.

It should be noted that, in the above description, the voice recognition system has been explained that executes voice recognition by use of a signal obtained by signal synthesis executed depending on whether or not clipping is found; however, the present disclosure is not limited to this example. The present disclosure is applicable to any apparatuses configured to execute signal processing by use of a signal obtained by signal synthesis executed depending on whether or not clipping is found.

The above-mentioned sequence of processing operations may be executed by software as well as hardware. If the above-mentioned sequence of processing operations is executed by software, a program constituting the software is installed in a computer. Here, the computer includes a computer built in dedicated hardware equipment, a general-purpose personal computer in which various programs may be installed for the execution of various functions, or the like.

### [Exemplary Configuration of Computer]

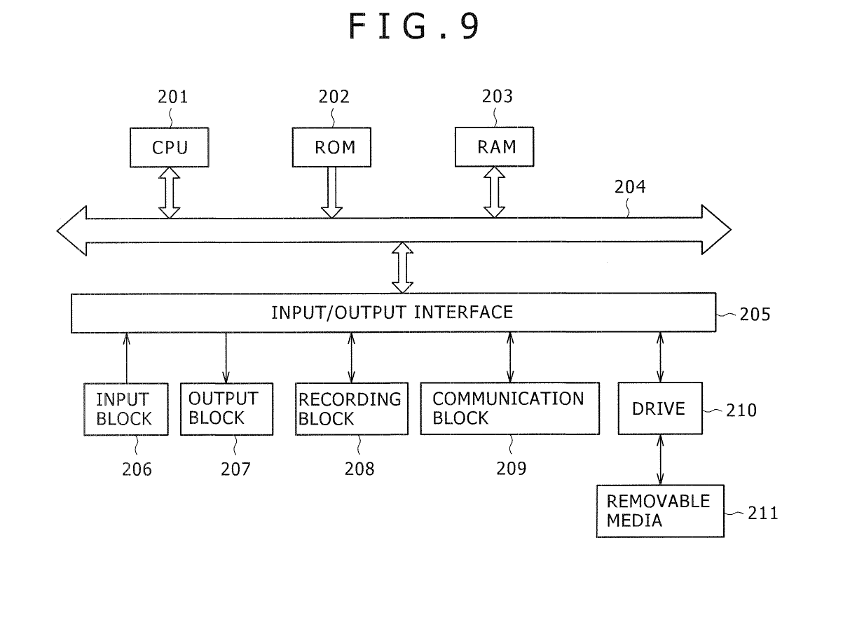

Referring to FIG. 9, there is shown an exemplary hardware configuration of a computer configured to execute the above-mentioned sequence of processing operations by use of computer programs.

In the computer, a CPU (Central Processing Unit) 201, a ROM (Read Only Memory) 202, and a RAM (Random Access Memory) 203 are interconnected by a bus 204.

The bus 204 is connected with an input/output interface 205. The input/output interface 205 is connected with an input block 206, an output block 207, a recording block 208, a communication block 209, and a drive 210.

The input block 206 includes a keyboard, a mouse, and a microphone, for example. The output block 207 includes a display and a speaker, for example. The recording block 208 includes a hard disk unit or a nonvolatile memory, for example. The communication block 209 includes a network interface, for example. The drive 210 drives a removable media 211 such as a magnetic disk, an optical disk, a magneto optical disk or a semiconductor memory.

In the computer configured as described above, the CPU 201 loads a program from the recording block 208 into the RAM 203 via the input/output interface 205 and the bus 204 for execution, for example, thereby executing the above-mentioned sequence of processing operations.

Each program to be executed by the computer (or the CPU 201) may be recorded to the removable media 211 that is a package media for example to be provided. Each program may also be provided through a wired or wireless transmission media such as a local area network, the Internet, and digital satellite broadcasting.

In the computer, each program may be installed, via the input/output interface 205, in the recording block 208 by loading the removable media 211 in which that program is recorded onto the drive 210. Each program may also be received at the communication block 209 via wired or wireless transmission media to be installed in the recording block 208. Further, each program may be installed in the ROM 202 or the recording block 208 in advance.

It should be noted that each program to be executed by the computer may be executed in a time-dependent manner along the sequence described herein, in a parallel manner, or in an on-demand basis.

It should also be noted that, herein, the steps used to describe the above-mentioned sequence of processing operations may include processing to be executed in parallel or individually, in addition to processing to be executed in a time-dependent manner in accordance with the sequence described herein.

The embodiments of the present disclosure are not limited to those described above; variations and changes may occur as long as no departure is done from the spirit of the present disclosure.

Each of the steps described with reference to above-mentioned flowcharts may be executed by one apparatus or two or more apparatuses in a divided manner.

If two or more processing operations are included in one step, then these processing operations may be executed by two or more apparatuses in a distributed manner in addition to the execution by a single apparatus.

Each configuration described above as one apparatus (or a processing block) may be divided in configuration into two or more apparatuses (or processing blocks). A configuration described above as two or more apparatuses (or processing blocks) may be configured as one apparatus (or one processing block). In addition, another configuration may be added to the configuration of each apparatus (or each processing block) described above. Further, if the configuration and operation of the entire system are substantially the same, part of the configuration of a certain apparatus (or a certain processing block) may be included in the configuration of another apparatus (or another processing block). The present disclosure is not limited to the embodiments described above; therefore, variations and changes may occur as long as no departure is done from the spirit of the present disclosure.

The preferred embodiments of the present disclosure have been explained by referring to the accompanying diagrams so far. However, the scope of the present disclosure is by no means limited to these embodiments. It is obvious that a person having ordinary knowledge in the technical field of the present disclosure is capable of thinking of a variety of changes and a variety of modifications within the ranges of technological concepts described in the claims. It is a matter of course that such changes and modifications are also included in the technological range of the present disclosure.

It should be noted that the present disclosure may take the following configuration.

(1) A signal processing apparatus including:

a first A/D converter configured to execute A/D conversion by adjusting an input signal with a first gain;

a second A/D converter configured to execute A/D conversion by adjusting an input signal with a second gain that is smaller than the first gain;

a synthesis block configured to synthesize a first signal obtained by conversion by the first A/D converter with a second signal obtained by conversion by the second A/D converter output a resultant synthesized signal if the first signal is clipped; and

a signal processing block configured to execute signal processing by use of the signal outputted from the synthesis block.

(2) The signal processing apparatus according to (1) above, in which the signal processing block executes voice recognition processing by use of the signal outputted from the synthesis block.

(3) The signal processing apparatus according to (1) or (2) above, in which the synthesis block enters the first signal and the second signal for each window section and, if a window section of the entered first signal is clipped, synthesizes the first signal with the second signal to output a synthesized signal.

(4) The signal processing apparatus according to (3) above, in which, for the window section in which the first signal is clipped, the synthesis block replaces the window section of the first signal by a window section of the second signal and synthesizes the first signal with the second signal to output a resultant synthesized signal.

(5) The signal processing apparatus according to (3) above, in which, for a clipped sample part of the window section in which the first signal is clipped, the synthesis block replaces the part by a value obtained by increasing the second signal by a difference between the first gain and the second gain and synthesizes the first signal with the second signal to output a resultant synthesized signal.

(6) The signal processing apparatus according to (3) above, in which, for a clipped sample part of the window section in which the first signal is clipped, the synthesis block replaces the part by a value obtained by increasing the second signal by a difference between the first gain and the second gain, executes bit adjustment, and synthesizes the first signal with the second signal to output a resultant synthesized signal.

(7) The signal processing apparatus according to (3) above, in which, if the window section of the first signal is not clipped, the synthesis block outputs the first signal.

(8) The signal processing apparatus according to (1) or (2) above, in which, for a part in which the first signal is clipped, the synthesis block replaces the part by a value obtained by increasing the second signal by a difference between the first gain and the second gain and synthesizes the first signal with the second signal to output a resultant synthesized signal.

(9) The signal processing apparatus according to (8) above, in which, if the first signal is not clipped, the synthesis block outputs the first signal.

(10) A signal processing method executed by a signal processing apparatus, including:

executing first A/D conversion by adjusting an input signal with a first gain;

executing second A/D conversion by adjusting an input signal with a second gain that is smaller than the first gain;

synthesizing a first signal obtained by the first A/D conversion with a second signal obtained by the second A/D conversion to output a resultant synthesized signal if the first signal is clipped; and

executing signal processing by use of the signal thus synthesized and outputted.

(11) A program configured to cause a computer to execute processing including:

executing A/D conversion by adjusting an input signal with a first gain by a first A/D converter;

executing A/D conversion by adjusting an input signal with a second gain that is smaller than the first gain by a second A/D converter;

synthesizing a first signal obtained by conversion by the first A/D converter with a second signal obtained by conversion by the second A/D converter to output a resultant synthesized signal if the first signal is clipped; and

executing signal processing by use of the signal thus synthesized and outputted.

The present disclosure contains subject matter related to that disclosed in Japanese Priority Patent Application JP 2012-107458 filed in the Japan Patent Office on May 9, 2012, the entire content of which is hereby incorporated by reference.

What is claimed is:

1. A signal processing apparatus comprising:
a first A/D (Analog/Digital) converter configured to execute A/D conversion by adjusting an input signal with a first gain;
a second A/D converter configured to execute A/D conversion by adjusting an input signal with a second gain that is smaller than the first gain;
a synthesis block configured to synthesize a first signal obtained by conversion by the first A/D converter with a second signal obtained by conversion by the second A/D converter to output a resultant synthesized signal if the first signal is clipped; and
a signal processing block configured to execute signal processing by use of the signal outputted from the synthesis block.

2. The signal processing apparatus according to claim 1, wherein the signal processing block executes voice recognition processing by use of the signal outputted from the synthesis block.

3. The signal processing apparatus according to claim 2, wherein the synthesis block enters the first signal and the second signal for each window section and, if a window section of the entered first signal is clipped, synthesizes the first signal with the second signal to output a synthesized signal.

4. The signal processing apparatus according to claim 3, wherein, for the window section in which the first signal is clipped, the synthesis block replaces the window section of the first signal by a window section of the second signal and synthesizes the first signal with the second signal to output a resultant synthesized signal.

5. The signal processing apparatus according to claim 3, wherein, for a clipped sample part of the window section in which the first signal is clipped, the synthesis block replaces the part by a value obtained by increasing the second signal by a difference between the first gain and the second gain and synthesizes the first signal with the second signal to output a resultant synthesized signal.

6. The signal processing apparatus according to claim 3, wherein, for a clipped sample part of the window section in which the first signal is clipped, the synthesis block replaces the part by a value obtained by increasing the second signal by a difference between the first gain and the second gain, executes bit adjustment, and synthesizes the first signal with the second signal to output a resultant synthesized signal.

7. The signal processing apparatus according to claim 3, wherein, if the window section of the first signal is not clipped, the synthesis block outputs the first signal.

8. The signal processing apparatus according to claim 2, wherein, for a part in which the first signal is clipped, the synthesis block replaces the part by a value obtained by increasing the second signal by a difference between the first gain and the second gain and synthesizes the first signal with the second signal to output a resultant synthesized signal.

9. The signal processing apparatus according to claim 8, wherein, if the first signal is not clipped, the synthesis block outputs the first signal.

10. A signal processing method executed by a signal processing apparatus, comprising:
executing first A/D (Analog/Digital) conversion by adjusting an input signal with a first gain;
executing second A/D conversion by adjusting an input signal with a second gain that is smaller than the first gain;
synthesizing a first signal obtained by the first A/D conversion with a second signal obtained by the second A/D conversion to output a resultant synthesized signal if the first signal is clipped; and
executing signal processing by use of the signal thus synthesized and outputted.

11. A program configured to cause a computer to execute processing comprising:
executing A/D (Analog/Digital) conversion by adjusting an input signal with a first gain by a first A/D converter;
executing A/D conversion by adjusting an input signal with a second gain that is smaller than the first gain by a second A/D converter;
synthesizing a first signal obtained by conversion by the first A/D converter with a second signal obtained by conversion by the second A/D converter to output a resultant synthesized signal if the first signal is clipped; and
executing signal processing by use of the signal thus synthesized and outputted.
